(19) United States
(12) Patent Application Publication
(10) Pub. No.: US 2008/0232630 A1
(43) Pub. Date: Sep. 25, 2008

(54) Condenser microphone package

(75) Inventors: Ray-Hua Horng, Taichung City (TW); Chao-Chih Chang, Taichung City (TW); Jean-Yih Tsai, Taichung Hsien (TW); Gu-Yu Hu, Taipei Hsien (TW); Yu-Ning Jing, Pingtung City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: National Chung-Hsing University, Taichung City (TW)

(21) Appl. No.: 11/725,737

(22) Filed: Mar. 19, 2007

(51) Int. Cl. H04R 17/02

(52) U.S. Cl. 381/361

(57) ABSTRACT

A condenser microphone package includes: a condenser microphone unit including a diaphragm and a back plate; a printed circuit board; a conductive connector sandwiched between and cooperating with the condenser microphone unit and the printed circuit board to form a stack; and a metal can encasing the stack and having a first end wall that is formed with a plurality of sound holes, and that abuts against the condenser microphone unit, and a second end wall that is disposed opposite to the first end wall, that abuts against the printed circuit board, and that cooperates with the first end wall to press the printed circuit board toward the condenser microphone unit.

### BACKGROUND OF THE INVENTION

1. Field of the invention

This invention relates to a condenser microphone package, more particularly to a condenser microphone package including a metal can enclosing and pressing a condenser microphone unit against a printed circuit board.

2. Description of the related art

Micro Electro Mechanical System microphones (MEMS mics) take advantages of semiconductor processing and thus have a size much smaller than conventional Electret Condenser Microphones (ECMs). MEMS mics are also perfect candidates for chip-scale packaging in integration with components, such as a printed circuit board (PCB), capacitors and Field Effect Transducer (FET). Conventional MEMS mics normally include a back plate and a diaphragm which are formed on a silicon substrate along with necessary electrical connections through semiconductor processing techniques. FIG. 1 illustrates a conventional MEMS mic package that includes a device-mounting board 11 with leads 112, a condenser microphone 13 having a silicon substrate 131 mounted on the device-mounting board 11 and connected electrically to the leads 112 through bonding wires 132, and a lid 14 covering the device-mounting board 11 and the condenser microphone 13. The MEMS mic package thus formed is to be mounted on an external circuit board (not shown) and connected to external electrical components (not shown), such as FET, capacitors, and other ICs, through the leads 112.

The conventional MEMS mic package thus formed is disadvantageous in that since the silicon substrate 131 is relatively fragile, electrical connection of the condenser microphone 13 to a device-mounting board 11 or a PCB is normally conducted through wire bonding techniques, which results in an increase in the manufacturing costs and in the size of the package thus formed.

### SUMMARY OF THE INVENTION

Therefore, the object of the present invention is to provide a condenser microphone package that can overcome the aforesaid drawback of the prior art.

According to the present invention, there is provided a condenser microphone package that comprises: a condenser microphone unit including a diaphragm and a back plate connected to and cooperating with the diaphragm to define a variable gap therebetween; a printed circuit board; a conductive connector sandwiched between and cooperating with the condenser microphone unit and the printed circuit board to form a stack, the conductive connector being electrically connected to the printed circuit board and one of the diaphragm and the back plate, and a metal can encasing the stack and having a surrounding wall that surrounds the stack, a first end wall that extends from the surrounding wall, that is formed with a plurality of sound holes, and that abuts against the condenser microphone unit, and a second end wall that extends from the surrounding wall, that is disposed opposite to the first end wall, that abuts against the printed circuit board, and that cooperates with the first end wall to press the printed circuit board toward the condenser microphone unit.

### BRIEF DESCRIPTION OF THE DRAWINGS

In drawings which illustrate embodiments of the invention,

FIG. 1 is a schematic view of a conventional condenser microphone package;

FIG. 2 is a schematic sectional view of the first preferred embodiment of a condenser microphone package according to this invention;

FIG. 3 is a schematic view of a condenser microphone unit of the first preferred embodiment;

FIG. 4 is a schematic sectional view of the second preferred embodiment of the condenser microphone package according to this invention;

FIG. 5 is a schematic view of a condenser microphone unit of the third preferred embodiment of the condenser microphone package according to this invention; and

FIGS. 6A to 6H are schematic views to illustrate consecutive steps of a method for making the condenser microphone unit of the first preferred embodiment.

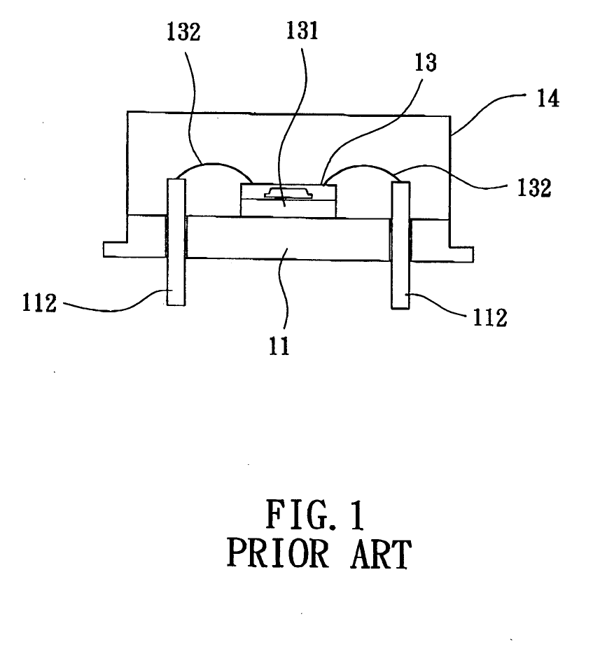

### DETAILED DESCRIPTION OF THE PREFERRED EMBODIMENTS

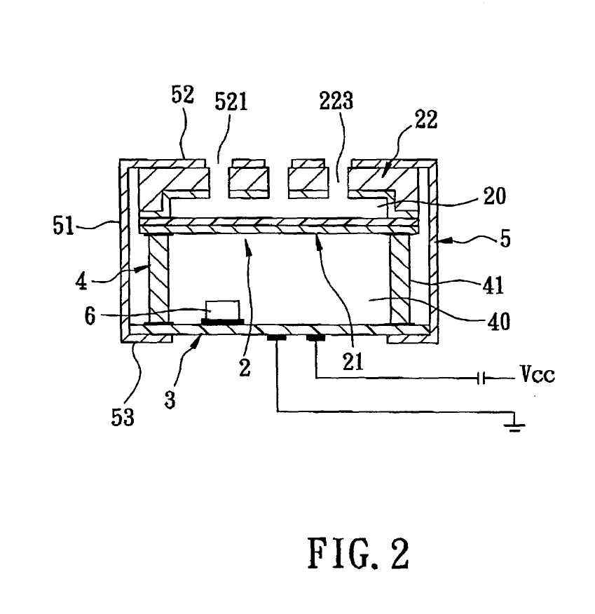

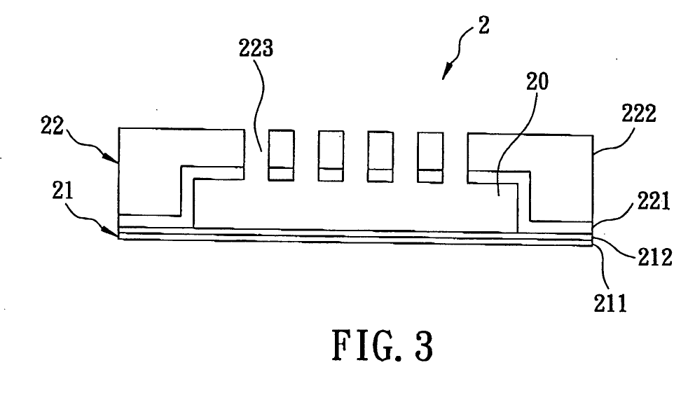

FIGS. 2 and 3 illustrate the first preferred embodiment of a condenser microphone package according to this invention. The condenser microphone package includes: a condenser microphone unit 2 including a diaphragm 21 and a back plate 22 connected to and cooperating with the diaphragm 21 to define a variable gap 20 therebetween; a printed circuit board 3; a conductive connector 4 sandwiched between and cooperating with the condenser microphone unit 2 and the printed circuit board 3 to form a stack, the conductive connector 4 being electrically connected to the printed circuit board 3 and one of the diaphragm 21 and the back plate 22; and a metal can 5 encasing the stack and having a surrounding wall 51 that surrounds the stack, a first end wall 52 that extends from the surrounding wall 51, that is formed with a plurality of first sound holes 521, and that abuts against the condenser microphone unit 2, and a second end wall 53 that extends from the surrounding wall 51, that is disposed opposite to the first end wall 52, that abuts against the printed circuit board 3, and that cooperates with the first end wall 52 to press the printed circuit board 3 toward the condenser microphone unit 2, thereby ensuring electrical connection between the printed circuit board 3 and the condenser microphone unit 2 through the conductive connector 4.

In this embodiment, the back plate 22 is disposed between the first end wall 52 of the metal can 5 and the diaphragm 21, and is formed with a plurality of second sound holes 223 in fluid communication with the first sound holes 521 and the variable gap 20. The diaphragm 21 has first conductive layer 211 that serves as a first electrode, and a dielectric layer 212 formed on the first conductive layer 211. The back plate 22 has a second conductive layer 221 that is formed on the dielectric layer 212 and that serves as a second electrode, and a reinforcing layer 222 that is formed on the second conductive layer 221 and that is made from a material selected from the group consisting of Ni, Cu, Co, acrylic material, and polyimide. The first and second conductive layers 211, 221 are made from a metal selected from the group consisting of Cr, Au, Ta, Pt, Al, Pd, W, Cu, and Ni. The dielectric layer 212 is preferably made from a material selected from the group consisting of polyimide, silicon nitride, and silicon dioxide.

The conductive connector 4 has an encircling wall 41 that cooperates with the condenser microphone unit 2 and the printed circuit board 3 to define an accommodating space 40 therein. The condenser microphone package can further include integrated electronic components 6, such as a field effect transistor and capacitors, mounted on the printed circuit board 3 and disposed in the accommodating space 40.

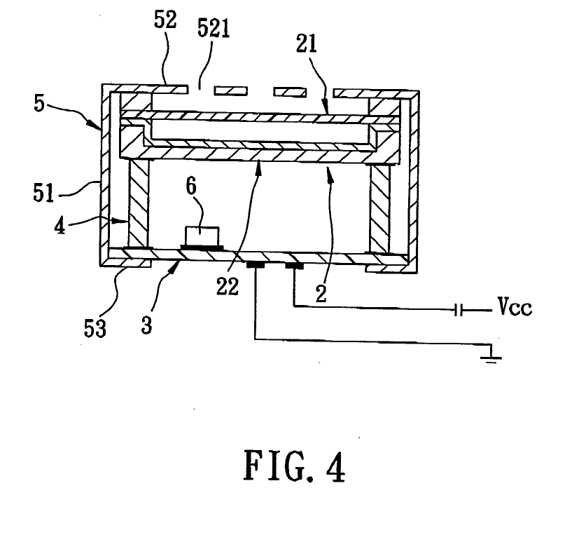

FIG. 4 illustrates the second preferred embodiment of the condenser microphone package according to this invention. The second preferred embodiment differs from the previous embodiment in that the condenser microphone unit 2 is reversed, i e., the diaphragm 21 is disposed between the first end wall 52 of the metal can 5 and the back plate 22 and the conductive connector 4 abuts against the backplate 22. In this embodiment, formation of the second sound holes 223 in the back plate 22 is dispensed with.

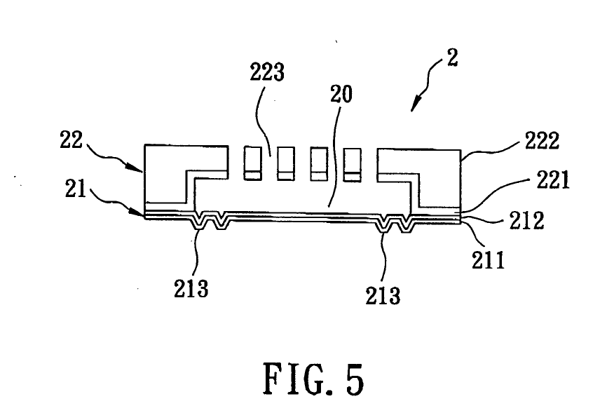

FIG. 5 illustrates the third preferred embodiment of the condenser microphone package according to this invention. The third preferred embodiment differs from the previous embodiments in that the diaphragm 21 is formed with a plurality of folded regions 213.

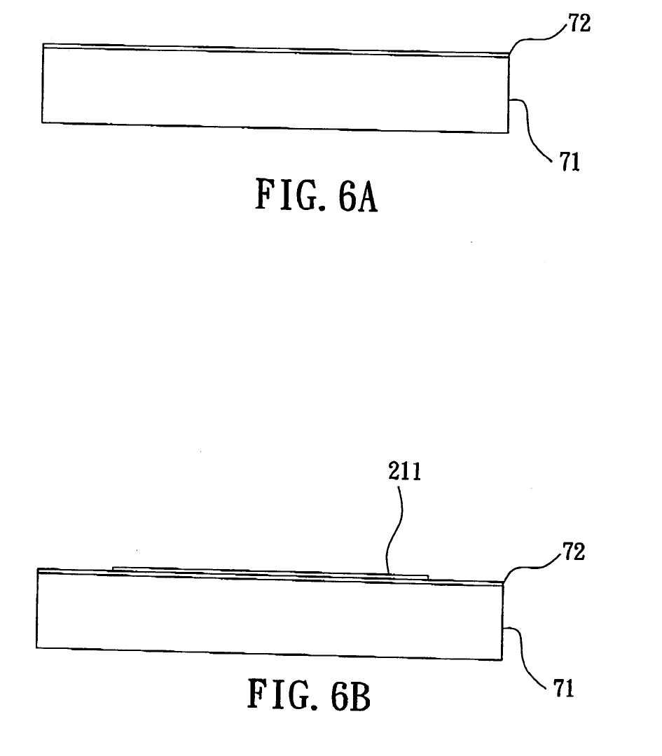

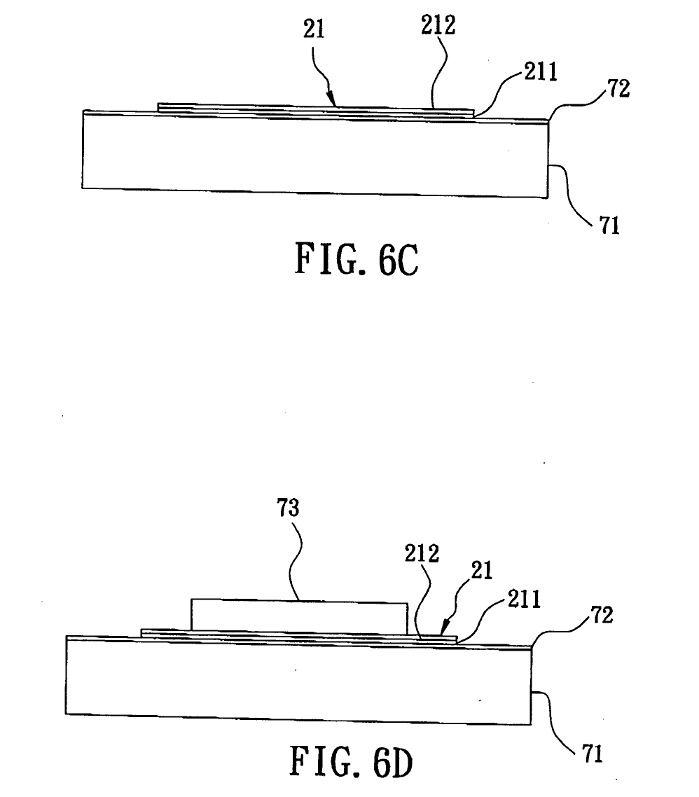

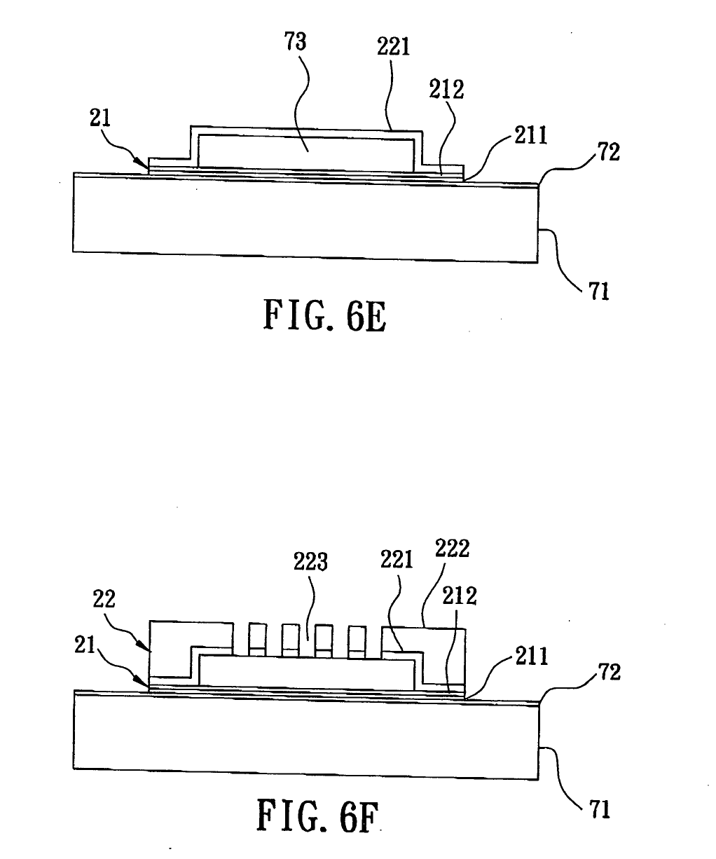

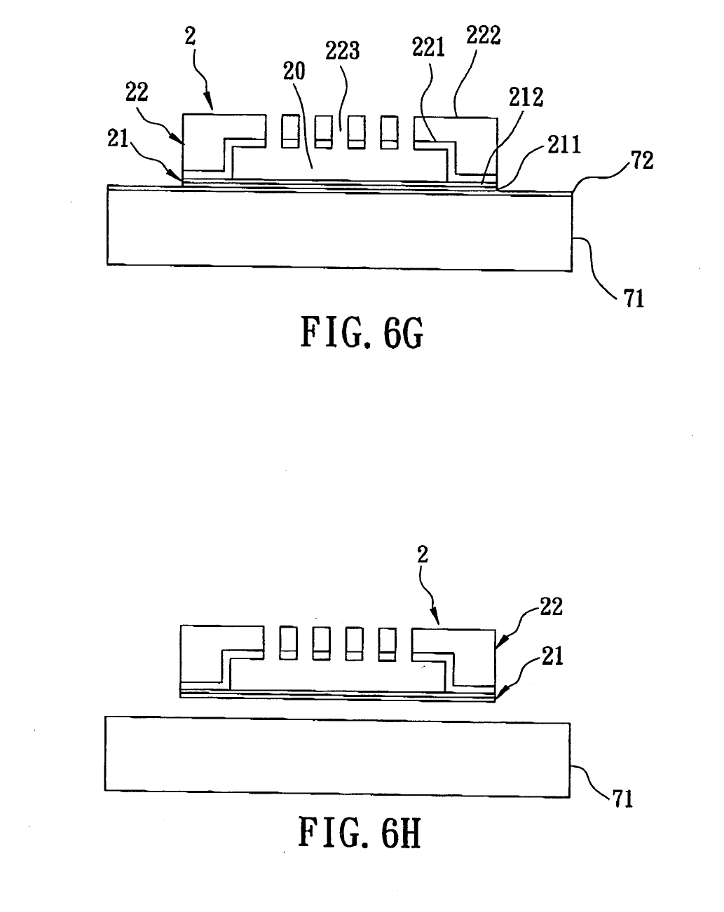

FIGS. 6A to 6H illustrate consecutive steps of a method for making the condenser microphone unit 2 of the first preferred embodiment using semiconductor processing techniques. The method includes the steps of: forming a liftoff layer 72 on a silicon substrate 71 (see FIG. 6A); forming the first conductive layer 211 on the liftoff layer 72 (see FIG. 6B); forming the dielectric layer 212 on the first conductive layer 211 (see FIG. 6C); forming a sacrificial layer 73 on the dielectric layer 212 (see FIG. 6D); forming the second conductive layer 221 on the sacrificial layer 73 and a portion of the dielectric layer 212 that surrounds the sacrificial layer 73 (see FIG. 6E); forming the reinforcing layer 222 on the second conductive layer 221 (see FIG. 6F); forming a plurality of second sound holes 223 in the back plate 22 (see FIG. 6F); removing the sacrificial layer 73 from the diaphragm 21 by etching techniques using a BOE solution so as to form the variable gap 20 (see FIG. 6G); and separating the condenser microphone unit 2 from the silicon substrate 71 by etching the liftoff layer 72 using a hydrochloric acid solution. The condenser microphone unit 2 thus formed is ready for insertion into the metal can 5, and can be pressed during assembly thereof with the conductive connector 4 and the printed circuit board 3 to form the stack and to permit electrical connection between the printed circuit board 3 and the condenser microphone unit 2 through the conductive connector 4. It is noted that when using a conventional condenser microphone unit, which includes a silicon substrate, the pressing action can result in breaking of the silicon substrate due to the fragile property thereof, thereby damaging the entire condenser microphone unit.

With the inclusion of the metal can 5, which includes the first and second end walls 52, 53 cooperatively serving as clamping means to maintain electrical connection between the printed circuit board 3 and the condenser microphone unit 2 and the integrity of the stack, in the condenser microphone package of this invention, the aforesaid drawback of the prior art can be eliminated.

With the invention thus explained, it is apparent that various modifications and variations can be made without departing from the spirit of the present invention. It is therefore intended that the invention be limited only as recited in the appended claims.

What is claimed is:

1. A condenser microphone package comprising:
a condenser microphone unit including a diaphragm and a back plate connected to and cooperating with said diaphragm to define a variable gap therebetween;
a printed circuit board;
a conductive connector sandwiched between and cooperating with said condenser microphone unit and said printed circuit board to form a stack, said conductive connector being electrically connected to said printed circuit board and one of said diaphragm and said back plate; and
a metal can encasing said stack and having a surrounding wall that surrounds said stack, a first end wall that extends from said surrounding wall, that is formed with a plurality of first sound holes, and that abuts against said condenser microphone unit, and a second end wall that extends from said surrounding wall, that is disposed opposite to said first end wall, that abuts against said printed circuit board, and that cooperates with said first end wall to press said printed circuit board toward said condenser microphone unit.

2. The condenser microphone package of claim 1, wherein said conductive connector has an encircling wall that cooperates with said condenser microphone unit and said printed circuit board to define an accommodating space therein.

3. The condenser microphone package of claim 2, further comprising a field effect transistor mounted on said printed circuit board and disposed in said accommodating space.

4. The condenser microphone package of claim 1, wherein said diaphragm is disposed between said first end wall of said metal can and said back plate, said conductive connector abutting against said back plate.

5. The condenser microphone package of claim 1, wherein said back plate is disposed between said first end wall of said metal can and said diaphragm, and is formed with a plurality of second sound holes.
